(19) United States
(12) Patent Application Publication
(10) Pub. No.: US 2025/0258447 A1
(43) Pub. Date: Aug. 14, 2025

(54) ELECTROGRAPHIC TONERS

(71) Applicant: Hewlett-Packard Development Company, L.P., Spring, TX (US)

(72) Inventors: DongWon Kim, Seongnam Si (KR); Sungjun Cho, Seongnam Si (KR); SungDong Lee, Seongnam Si (KR); Sung Jin Park, Seongnam Si (KR); Sukjin Kang, Seongnam Si (KR); Insik Choi, Seongnam Si (KR); Jinmo Hong, Seongnam Si (KR)

(21) Appl. No.: 18/703,540

(22) PCT Filed: Oct. 25, 2021
(86) PCT No.: PCT/US2021/056417

§ 371 Date: Apr. 22, 2024

(51) Int. Cl. G03G 9/093; G03G 9/08; G03G 9/09

(52) U.S. Cl. CPC G03G 9/09342; G03G 9/0808; G03G 9/0819; G03G 9/0906; G03G 2215/0604

(57) ABSTRACT

An electrographic toner can include toner particles having a multi-particulate additive disposed on an exterior surface of the toner particles. The toner particles can have a specific surface area from 3.0 m²/g to 3.65 m²/g and can include a binder resin, a colorant, and a releasing compound. The multi-particulate additive can include aluminum oxide particles, small sol-gel silica particles having a particle size distribution from 20 nm to 50 nm, large sol-gel silica particles having a particle size distribution from 90 nm to 130 nm, and fumed silica particles surface-treated with polydimethylsiloxane (PDMS).

### BACKGROUND

Electrographic printing involves creating an image on a photoconductive surface or photo imaging plate (PIP). The image that is formed is a latent electrographic image having image and background areas with different potentials. When an electrographic toner including charged toner particles is brought into contact with the selectively charged photoconductive surface, the charged toner particles adhere to the charged areas of the latent electrographic image and background areas remain clear. The charged toner particles may then be transferred from the photoconductive surface to a print substrate using an intermediate transfer member.

### BRIEF DESCRIPTION OF THE DRAWINGS

FIG. 1 is a schematic illustration of an example of a cross-sectional view of a particle in an electrographic toner in accordance with the present disclosure.

FIG. 2 is a flow diagram illustration of an example method of making an electrographic toner in accordance with the present disclosure. FIG. 3 is a flow diagram illustration of an example method of forming an

image in accordance with the present disclosure.

### DETAILED DESCRIPTION

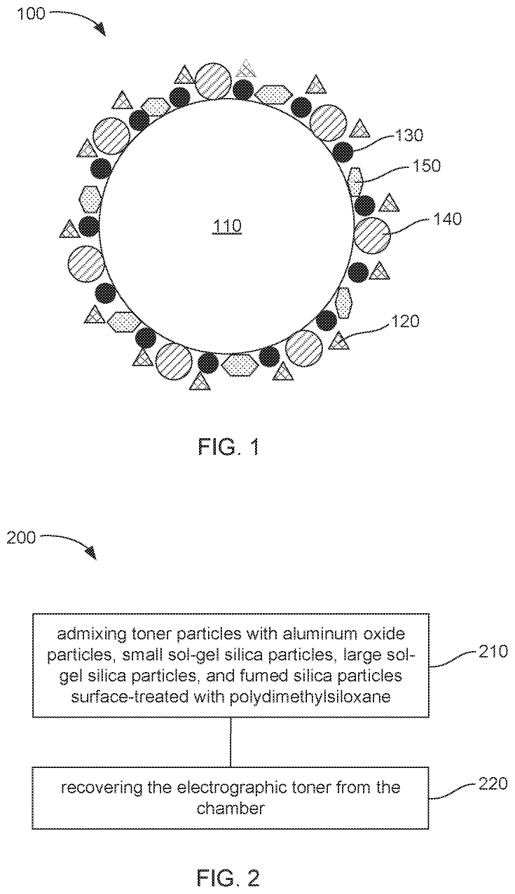

The present disclosure is drawn to electrographic toner and related methods. The electrographic toner can be a chargeable toner for use in electrographic printing. In accordance with examples herein, an electrographic toner 100 is illustrated in FIG. 1 and includes toner particles 110 having a multi-particulate additive disposed on the surface thereof. In some examples, the electrographic toner (as a whole) can have a D50 particle size from 3 μm to 9 μm, from 4 μm to 8 μm, from 3 μm to 6 μm, or from 6 μm to 9 μm. The toner particles can have a specific surface area from 3.0 m²/g to 3.65 m²/g and can include a binder resin, a colorant, and a releasing compound. The multi-particulate additive can include aluminum oxide particles 120, small sol-gel silica particles 130 having a particle size distribution from 20 nm to 50 nm and a circularity of 0.9 to 1, large sol-gel silica particles 140 having a particle size distribution from 90 nm to 130 nm, and fumed silica particles 150 surface-treated with polydimethylsiloxane (PDMS). In some examples, the aluminum oxide particles can have a D50 particle size from about 10 nm to about 30 nm, for example.

As used herein, D50 particle size is based on primary particle diameter and can be measured using a particle analyzer such as the Coulter Counter® (Multisizer 4) available from Beckman Coulter Life Sciences™ (Indianapolis, U.S.). The Coulter Counter® user Coulter principle to detect particles using electrical zone sensing. The Coulter principle analyzes voltage pulses generated when suspended particles pass through an aperture under electrical current. The amplitude of the pulse is proportional to the volume of the particle. “D50” is defined as the particle size at which about 50% of the particles are larger than the D50 particle size and about 50% of the particles are smaller than the D50 particle size.

It is notable that the particle sizes here are reported either as falling within a range of a particle size distribution, or as a D50 particle size. When referring to a “particle size distribution” range, this refers to all of the particles of a type that fall within the range. For example, a particle size distribution range of 20 nm to 50 nm would include particles that are 20 nm in size, 50 nm in size, 25, nm in size, 40 nm in size, etc., but would exclude particles that are 55 nm in size or 15 nm in size. On the other hand, the “D50 particle size” refers to the D50 size of all particles of a given type. In both cases, the particle size ranges are based on particle number or count.

Regarding the toner particles more specifically, in further detail, this portion of the electrographic toner can include binder resin, colorant, and a releasing compound. The toner particles can be a chargeable toner particle. The binder resin, of the toner particle, in further detail, can be in the form of polymer particles. The polymer particles can include polystyrene-butylacrylate copolymer latex, a styrene-butylacrylate copolymer latex, a polyester-based latex, polyurethane, polyester-polystyrene latex, copolymers thereof, or admixtures thereof. The binder resin may be present at from 70 wt % to 95 wt %, from 70 wt % to 90 wt %, from 75 wt % to 85 wt %, from 80 wt % to 90 wt %, or from 85 wt % to 95 wt % based on a total weight of the toner particles.

The toner particles can further include a colorant. The colorant is not particularly limited and can include pigment particles. The pigment particles may include black, cyan, magenta, and/or yellow pigments. The colorant can be selected from a phthalocyanine, an indigold, an indanthrone, an azo, a monoazo, a diazo, a dioxazine, a perylene, an anthraquinone, a quinacridone, an organic material, an inorganic salt, or the like. In an example, the pigment can include carbon black. The colorant can be present in the toner particles at from 4 wt % to 20 wt %, from 5 wt % to 15 wt %, from 4 wt % to 12 wt %, from 10 wt % to 20 wt %, or from 8 wt % to 16 wt % based on a total weight of the toner particles.

The toner particles can further include a releasing compound. The releasing compound can include polyethylene-based wax, a polypropylene-based wax, a silicone-based wax, a paraffin-based wax, an ester-based wax, a carnauba-based wax, a metallocene-based wax, or a combination thereof. The releasing compound can be present at from 2 wt % to 10 wt %, from 3 wt % to 10 wt %, from 5 wt % to 10 wt %, or from 3 wt % to 8 wt %, based on a total weight of the toner particles.

The toner particles can have a BET (Brunauer, Emmett, and Teller) specific surface area (or “specific surface area”) ranging from 3.0 m²/g to 3.65 m²/g. In yet other examples, the toner particles can have a BET specific area ranging from 3 m²/g to 3.5 m²/g, from 3.25 m²/g to 3.5 m²/g, from 3.2 m²/g to 3.4 m²/g, or from 3.4 m²/g to 3.6 m²/g. BET specific surface area is a measure of physical adsorption of gas molecules on a solid surface. BET specific surface area can be determined by a multipoint BET nitrogen absorption method according to ASTM D-1993-03. As an example, toner can be placed in cells and pretreated with N₂ at 30° C. for 30 minutes. Measuring conditions can be as follows: helium carrier, nitrogen adsorbate, 25 mL/min flow rate, 900 seconds. After 3 measurements, the average value and standard deviation can then be calculated.

A multi-particulate additive can be applied to a surface of the toner particles, and thus, when applied, can surround and coat the toner particles. The multi-particulate additive can include aluminum oxide particles, for example. The aluminium oxide particles may be surface treated with a hydrophobic compound. The aluminum oxide particles can have a D50 particle size that can range from 10 nm to 30 nm, from 15 nm to 30 nm, from 10 nm to 20 nm, or from 20 nm to 30 nm.

The aluminum oxide particles can have a BET specific surface area from 80m²/g to 120 m²/g. In yet other examples, the specific surface area can range from 80 m²/g to 90 m²/g, from 90 m²/g to 100 m²/g, from 100 m²/g to 110 m²/g, from 110 m²/g to 120 m²/g, from 80 m²/g to 100 m²/g, from 90 m²/g to 110 m²/g, or from 100 m²/g to 120 m²/g.

The aluminum oxide particles can be present at from 0.3 parts by weight to 1.5 parts by weight per 100 parts by weight of the toner particles. In yet other examples, an amount of the aluminum oxide particles can range from 0.4 parts by weight to 1 parts by weight, from 0.4 parts by weight to 0.8 parts by weight, or from 0.4 parts by weight to 0.75 parts by weight, per 100 parts by weight of the toner particles.

In instances where a hydrophobic compound is included with the aluminum oxide, this may include a C4 to C10 alkyl silane, a C4 to C8 alkyl silane, a C6 to C10 alkyl silane, or a C5 to C9 alkyl silane. In one example, the hydrophobic compound can be a C8 alkyl silane. The aluminum oxide can act to control charge of the toner particles, can prevent charge-up phenomena which can occur, and can improve the specific surface area of the toner particles thereby improving the thermal stability of the toner particles.

The multi-particulate additive can also include sol-gel silica particles. Sol-gel silica particles may be prepared by a solvent removal process including a hydrolysis and condensation reaction of a metal oxide in the solution containing an acid or base and a catalyst. Example metal alkoxides can include silica alkoxides such as sodium silicate (Na₂SiO₃), tetramethyl orthosilicate (Si(OCH₃)₄), tetraethyl orthosilicate (Si(OC₂H₅)₄), or the like. Silica alkoxides may be susceptible to hydrolysis and condensation reactions which can be enhanced by an acid or base catalyst. Example acid or base catalysts can include hydrogen chloride (HCl), hydrofluoric acid (HF), phosphoric acid (H₃PO₄), ammonia (NH₃), sodium hydroxide (NaOH), potassium hydroxide (KOH), ammonium hydroxide (NH₄OH), and ammonium fluoride (NH₄F). The hydrolysis and condensation reaction may occur in water, or water and an organic solvent such as methanol (CH₄), ethanol (C₂H₆O), acetone (C₃H₆O), or the like. The sol-gel silica particles may be colloidal sol-gel silica particles.

The sol-gel silica particles may be surface treated in some examples. The surface treatment can include silicone oils, silanes, siloxanes, or silazanes. In further detail, the surface treatment can include hexamethyldimethyl siloxane (HMDS), polydimethyl siloxane (PDMS), diethyldimethyl siloxane (DDS), dimethyltrimethoxy silane (DTMS), octyltriehoxysilane, or a combination thereof. In an example, the surface treatment can include a siloxane, and the siloxane can be selected from hexamethyldimethyl siloxane (HMDS), polydimethyl siloxane (PDMS), diethyldimethyl siloxane (DDS), or a combination thereof. In another example, the surface treatment can include a silane and the silane can be selected from dimethyltrimethoxy silane (DTMS), octyltriehoxysilane, or a combination thereof.

The sol-gel silica particles can include small sol-gel silica particles and large sol-gel silica particles. The small sol-gel silica particles can be present within a range of particles having a particle size distribution from 20 nm to 50 nm, from 30 nm to 50 nm, from 20 nm to 40 nm, or from 30 nm to 40 nm. The large sol-gel silica particles can be present within a range of particles having a particle size distribution from 90 nm to 130 nm, from 90 nm to 120 nm, from 100 nm to 130 nm, from 95 nm to 125 nm, or from 100 nm to 120 nm. As the sol-gel silica particles fall within one of the ranges set forth above, the D50 particle sizes of the sol-gel silica particles will likewise fall within these ranges. In some examples, however, the small sol-gel silica particles can have a D50 particle size from 30 nm to 40 nm and the large sol-gel silica particles can have a D50 particle size from 100 nm to 120 nm.

In some examples, the small sol-gel silica particles can have a BET specific surface area of from 30 m²/g to 60 m²/g, from 30 m²/g to 55 m²/g, from 30 m²/g to 40 m²/g, from 40 m²/g to 55 m²/g, from 30 m²/g to 45 m²/g, or from 32 m²/g to 52 m²/g. The large sol-gel silica particles can have a specific surface area of from 30 m²/g to 48 m²/g, from 30 m²/g to 45 m²/g, from 30 m²/g to 40 m²/g, from 40 m²/g to 50 m²/g, from 30 m²/g to 45 m²/g, from 35 m²/g to 45 m²/g, or from 35 m²/g to 43 m²/g. In an example, the small sol-gel silica particles can have a specific surface area from 30 m²/g to 60 m²/g and the large sol-gel silica particles can have a specific surface area from 30 m²/g to 48 m²/g.

The small sol-gel silica particles can be present at from 5 parts by weight to 40 parts by weight, from 10 parts by weight to 35 parts by weight, or from 15 parts by weight to 30 parts by weight, per 100 parts by weight of the toner particles. The large sol-gel silica particles can be present at from 5 parts by weight to 40 parts by weight, from 10 parts by weight to 35 parts by weight, from 5 parts by weight to 30 parts by weight, or from 15 parts by weight to 30 parts by weight, per 100 parts by weight of the toner particles. In one example, the small sol-gel silica particles can be present at from 15 parts by weight to 30 parts by weight and the large sol-gel silica particles can be present at from 5 parts by weight to 30 parts by weight, per 100 parts by weight of the toner particles.

The small sol-gel silica particles, and in many instances, the large sol-gel silica particles can have a circularity of from 0.9 to 1 (mean). In other examples, the circularity can be from 0.9 to 0.98, from 0.9 to 0.95, or from 0.95 to 1. Circularity is a measure of the circumference of a particle at a circle of equivalent area divided by the actual perimeter of the particle and is based on the D50 circumference. With respect to circularity, the more spherical the particle the closer the circularity is to 1. The more elongated or rough-edged the particle is, the lower the circularity. Circularity can be measured using a flow particle image analyzer such as the Sysmex FPIA 3000 instrument. Circularity is determined by equation 1.

$$Circularity = \frac{2 √ π Ap}{Pp} \qquad Equation 1$$

In Equation 1, Ap equals the area of the particle and Pp equals the perimeter of the particle.

Small sol-gel silica particles when used alone as part of the multi-particulate additive can become embedded in a surface of the toner particles. Large sol-gel silica particles can prevent agglomeration and provide spacing; however, large sol-gel silica particles when used alone may not adhere well to a surface of toner particles and may result in cleaning problems. When small sol-gel silica particles and large sol-gel silica particles are utilized in combination, the small sol-gel silica particles may cover exterior surface areas of toner particles that are not covered by the large sol-gel silica particles. The small silica particles do not embed during printing because the large sol-gel silica particles prevent compression of small sol-gel silica particles into the toner particles. The small sol-gel silica particles fill gaps between the large sol-gel silica particles and thereby minimize liberation of the large sol-gel silica particles from an exterior surface of the toner particles thereby improving adhesion. Accordingly, incorporating two different sized sol-gel silica particles in the multi-particulate additive may improve performance of the multi-particulate additive by reducing the adhesive force of the electrographic toner on a surface of the development member and transfer member during printing. The combination of these particles can also improve the durability of the toner, improve toner fluidity, improve triboelectric charge performance with the carrier, improve image durability, improve thermal stability, and improve charge stability.

The multi-particulate additive can further include fumed silica particles. Fumed silica particles can contribute to the cleaning properties of the electrographic toner. The fumed silica particles may be surface treated with polydimethylsiloxane (PDMS) at from 0.1 wt % to 2 wt %, from 0.5 wt % to 1.5 wt % or from 1 wt % to 2 wt %, based on a total weight of the fumed silica particles.

The fumed silica particles may have a D50 particle size ranging from 30 nm to 50 nm, from 30 nm to 40 nm, from 40 nm to 50 nm, or from 35 nm to 45 nm. The BET specific area of the fumed silica particle can range from 30 m²/g to 50 m²/g, from 30 m²/g to 40 m²/g, from 35 m²/g to 45 m²/g, or from 40 m²/g to 50 m²/g. If the BET specific area of the fumed silica particles is below 30 m²/g, then cleaning performance is decreased and OPC film formation can occur. If the specific surface area exceeds 50 m²/g, then triboelectric performance of the electrographic toner may be low.

A circularity of the fumed silica particles can range from 0.3 to 0.5. In some examples, the circularity can range from 0.3 to 0.4 or from 0.4 to 0.5. The circularity of the fumed silica particles may be less than 0.5 in order to prevent aggregation of the fumed silica particles. Maintaining circularity less than 0.5 can improve dispensability of the electrographic toner.

The fumed silica particles can be present at from 5 parts by weight to 30 parts by weight, from 10 parts by weight to 25 parts by weight, or from 15 parts by weight to 25 parts by weight, per 100 parts by weight of the toner particles.

In some more examples, the electrographic toner can include from about 50 wt % to about 85 wt % toner particles, or from about 55 wt % to about 80 wt % toner particles. The additives can be present in the range of 0.4 to 0.6 parts by weight aluminium oxide particles, from 15 to 30 parts by weight small sol-gel silica particles, from 5 to 30 parts by weight large sol-gel silica particles, and from 10 to 20 parts by weight fumed silica particles, each independently based on 100 parts by weight of the toner particles. In some examples, the electrographic toner can exclude titanium dioxide. Titanium dioxide has been used to prevent excessive triboelectric charging. However, titanium dioxide is classified by the European Union as a hazardous substance and has been reported to be carcinogenic in animal experiments. Accordingly, the electrographic toner can exclude titanium dioxide. The aluminum oxide particles can be used instead of titanium dioxide to prevent excessive triboelectric charging.

The electrographic toner may be loaded in a toner cartridge for electrostatic printing. In some examples, the electrographic toner may be packaged in a toner set with an individual toner cartridge for each color, for example, the toner may be co-packaged as several toner cartridges and can include a black toner cartridge including an electrographic toner with a black colorant, a cyan toner cartridge including an electrographic toner with a cyan colorant, a magenta toner cartridge including an electrographic toner with a magenta colorant, a yellow toner cartridge including an electrographic toner with a yellow colorant, or a combination thereof.

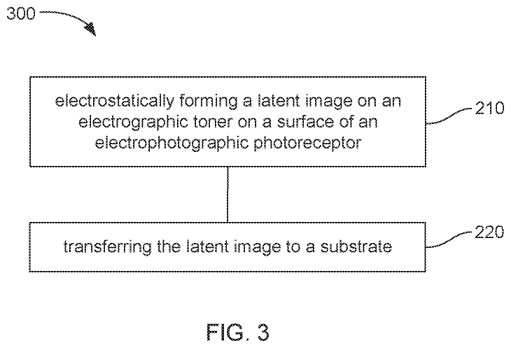

Methods of making electrographic toner 200 are shown by way of example in FIG. 2, and can include admixing 210 toner particles with aluminium oxide particles, small sol-gel silica particles having a particle size distribution from 20 nm to 50 nm, large sol-gel silica particles having a particle size distribution from 90 nm to 130 nm, and fumed silica particles having a D50 particle size from 30 nm to 50 nm that are surface treated with polydimethylsiloxane (PDMS). The toner particles, aluminium oxide particles, small sol-gel silica particles, large sol-gel silica particles, and fumed silica particles can be as described with respect to the electrographic toner previously. The admixing can occur in a chamber at an intensity sufficient to cause the toner particles to be surface-treated with the aluminum oxide particles, the small sol-gel silica particles, the large sol-gel silica particles, and the fumed silica particles. The aluminium oxide particles, the small sol-gel silica particles, the large sol-gel silica particles, and the fumed silica particles can become disposed on an exterior surface of the toner particles during admixing. In examples herein, the toner particles can have a specific surface area from 3.0 m²/g to 3.65 m²/g and can include a binder resin, a colorant, and a releasing compound. The methods can further include recovering 220 the electrographic toner from the chamber.

Admixing can be carried out in a mechanical mixer. Example mechanical mixers can include an acoustic mixer, a convective mixer, a powder mixer, a ribbon mixer, a tumbler mixer, a vertical mixer with a stirring mechanism, a pneumatic phase transport, a sieve, a hopper flow, and/or a tilt-table. A vertical mixer with a stirring mechanism can include a helical or auger-like stirrer. When the mechanical mixer is of a type that includes a rotational mixing element or structure, the mixing can occur at from 500 RPM to 10,000 RPM, from 500 RPM to 1,500 RPM, from 1,500 RMP to 2,500 RPM, from 1,500 RPM to 3,000 RPM, from 1,000 RPM to 3,000 RPM, from 2,000 RPM to 4,000 RPM, from 2,000 RPM to 8,000 RPM, from 4,000 RPM to 8,000 RPM, or from 5,000 RPM to 10,000 RPM for example. Time frames for admixing in these various types of mixers can range from 10 seconds to 15 minutes, from 15 seconds to 5 minutes, from 15 seconds to 45 seconds, from 15 seconds to 30 seconds, from 30 seconds to 1 minute, from 45 seconds to 2 minutes, from 1 minute to 3 minutes, or from 3 minutes to 5 minutes. In some instances, admixing multiple times can occur at different RPMs and time periods. For example, admixing can occur in a powder mixer at about 2,000 RPM for about 30 seconds, followed by a second admixing in the powder mixer at about 8,000 RPM for about 3 minutes. Following admixing, an exterior surface of the toner particles can have the aluminum oxide particles, small sol-gel silica particles, large sol-gel silica particles, and the fumed silica particles disposed thereon. Other mixing equipment, RPMs, times, etc., can be used in some examples.

The electrographic toner described herein can be used in methods 300 of forming images, as shown by way of example in FIG. 3, using processes such as electrophotographic printing. Electrophotographic printing can be carried out by printing onto a print substrate, such as a media substrate or an intermediate transfer member. As used in this disclosure, “electrophotographic printing” refers to a process that provides an image that is transferred from a photo imaging plate or other photo imaging substrate, e.g., roller, either directly onto a media substrate or indirectly onto media via an intermediate transfer member. In some examples, during electrophotographic printing, an image is first created on a photoconductive surface or photo imaging plate (PIP). The image that is formed on the photoconductive surface is a latent electrostatic image having image and background areas with different potentials. When an electrographic composition, such as an electrographic toner containing charged toner particles, is brought into contact with the selectively charged photoconductive surface, the charged toner particles adhere to the image areas of the latent image while the background areas remain clean. The image is then transferred to a print substrate (e.g. paper) either directly or by first being transferred to an intermediate transfer member (e.g. a soft swelling blanket) and then to the print substrate. Other electrophotographic printing systems can likewise be used in the alternative.

In accordance with the present disclosure, methods 300 of forming images can include electrostatically forming 310 a latent image of electrographic toner on a surface of an electrophotographic photoreceptor. The electrographic toner can include toner particles having a multi-particulate additive disposed on the surface thereof. The toner particles can include a binder resin, a colorant, and a releasing compound. The multi-particulate additive can include aluminium oxide particles, small sol-gel silica particles having a particle size distribution from 20 nm to 50 nm, large sol-gel silica particles having a particle size distribution from 90 nm to 130 nm, and fumed silica particles surface-treated with polydimethylsiloxane (PDMS). The electrographic toner can be as described previously. For example, the small sol-gel silica particles can be present from at from 10 to 40 parts by weight per 100 parts by weight of the toner particles and can have a specific surface area from 30 m²/g to 60 m²/g. In some examples, the large sol-gel silica particles can be present from 5 to 40 parts by weight per 100 parts by weight of the toner particles and can have a specific surface area from 30 m²/g to 48 m²/g. In other examples, the fumed silica particles can have a D50 particle size from 30 nm to 50 nm and can have a specific surface area from 20 m²/g to 60 m²/g, and may be present at from 5 to 30 parts by weight per 100 parts by weight of the toner particles. Following the formation of the latent image on the surface of the electrophotographic photoreceptor, the method includes transferring 320 the latent image to a substrate. The substrate can be an intermediate transfer member or can be a print substrate, for example. In some examples, the aluminum oxide particles can have a D50 particle size from 10 nm to 30 nm, a specific surface area from 80 mg²/g to 120 m²/g, and are surface treated with a hydrophobic compound including a C4 to C10 alkyl silane.

An intermediate transfer member can be a developing roller or have some other structure. In the example of the developing roller, this may be formed of an elastic material such as a polyurethane foam or sponge, or of other similar material. The developing roller may be arranged to face a photoreceptor while being spaced apart by a predetermined distance. The developing roller and the photoreceptor may rotate in opposite directions with respect to one another. The electrographic toner can then be transferred from the photoreceptor to the developing roller which can develop the latent image into a toner image using an electrostatic force generated by a potential difference based on voltage applied to the developing roller. The toner image once developed can be transferred to a print substrate.

In some examples, the latent image can be transferred directly to the print substrate following formation of the latent image. The print substrate can include any suitable substrate capable of having an image printed thereon. For example, the substrate may include a material selected from an organic material, an inorganic material, a natural polymeric material (e.g. cellulose), a synthetic polymeric material (e.g. a polymer formed from alkylene monomers, including, but not limited to, polyethylene and polypropylene, and co-polymers such as styrene-polybutadiene), a metal, which may be in sheet form, or a cellulosic paper, which may or may not be coated.

### Definitions

Terms used herein will have the ordinary meaning in their technical field unless specified otherwise. In some instances, there are terms defined more specifically throughout the specification or in this section of the present specification, and thus, these terms can have a meaning as described herein.

When discussing the electrographic toner, method of making an electrographic toner, and method of forming an image, these discussions can be considered applicable to one another whether or not they are explicitly discussed in the context of that example. Thus, for example, when discussing toner particles related to the electrographic toner, such disclosure is also relevant to and directly supported in the context of the method of making an electrographic toner, method of forming an image, and/or vice versa.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1—Formation of Electrographic Toners

Several electrographic toners were formulated by admixing toner particles (including a binder resin, a colorant, and a releasing compound) with additives in the range of 0.4-0.6 parts by weight aluminium oxide particles, 15-30 parts by weight small sol-gel silica particles, from 5-30 parts by weight large sol-gel silica particles, and from 10-20 parts by weight fumed silica particles. The parts by weight are independently based on 100 parts by weight of the toner particles. The details of the formulations prepared are shown as Sample IDs 1-3 and C1-C6, as indicated in Tables 1A and 1B, as follows:

TABLE 1A
Electrographic Toners

| | Aluminium Oxide | | | Fumed Silica | | | |
|---|---|---|---|---|---|---|---|
| | | | Specific | | | | Specific |
| | Av. | | Surface | Av. | | | Surface |
| Sample | Size | Hydrophobic | Area | Size | Siloxane | Circularity | Area |
| ID | (nm) | Component | (m²/g) | (nm) | Compound | (mean) | (mg²/g) |
| 1 | 13 | C8 alkyl | 108 | 40 | PDMS | 0.355 | 40 |
| | | silane | | | | | |
| 2 | 13 | C8 alkyl | 108 | 40 | PDMS | 0.355 | 50 |
| | | silane | | | | | |
| 3 | 13 | C8 alkyl | 90 | 30 | PDMS | 0.355 | 30 |
| | | silane | | | | | |
| C1 | 13 | C8 alkyl | 90 | 40 | PDMS | 0.355 | 40 |
| | | silane | | | | | |
| C2 | 13 | C8 alkyl | 90 | 40 | PDMS | 0.355 | 40 |
| | | silane | | | | | |
| C3 | 13 | None | 108 | 40 | *HDMS | 0.355 | 50 |
| C4 | N/A | | | 40 | PDMS | 0.355 | 50 |
| C5 | 13 | C8 alkyl | 108 | 40 | PDMS | 0.355 | 50 |
| | | silane | | | | | |
| C6 | 13 | C8 alkyl | 108 | 40 | PDMS | 0.355 | 80 |
| | | silane | | | | | |

*Hexadimethylsiloxane

TABLE 1B
Electrographic Toners

| | | | | | | | Toner |
|---|---|---|---|---|---|---|---|
| | Large Sol-gel Silica Particles | | | Small Sol-gel Silica Particles | | | Particles |
| | | | Specific | | | Specific | Specific |
| | Av. | | Surface | Av. | | Surface | Surface |
| Sample | Size | Circularity | Area | Size | Circularity | Area | Area |
| ID | (nm) | (mean) | (m²/g) | (nm) | (mean) | (m²/g) | (m²/g) |
| 1 | 116 | 0.945 | 35 | 30 | 0.915 | 32.5 | 3.25 ± 0.05 |
| 2 | 116 | 0.945 | 42.5 | 30 | 0.915 | 52 | 3.55 ± 0.05 |
| 3 | 116 | 0.945 | 42.5 | 40 | 0.915 | 45.5 | 3.15 ± 0.05 |
| C1 | *90 | 0.455 | 10 | 30 | 0.915 | 32.5 | 2.85 ± 0.05 |
| C2 | 116 | 0.9-1.0 | 42.5 | 30 | 0.375 | 24 | 2.95 ± 0.05 |
| C3 | 116 | 0.945 | 42.5 | 30 | 0.915 | 52 | 3.55 ± 0.05 |
| C4 | 116 | 0.945 | 42.5 | 30 | 0.915 | 52 | 2.55 ± 0.05 |
| C5 | 116 | 0.945 | 50 | 30 | 0.915 | 65 | 3.75 ± 0.05 |
| C6 | 116 | 0.945 | 42.5 | 30 | 0.915 | 40 | 3.85 ± 0.05 |

*Large Particle Size Distribution range was outside of 90 nm to 130 nm; Large Particle Size Distribution ranged from 90 nm to 130 nm for all examples except for C1; and Small Particle Size Distribution ranged from 20 nm to 50 nm for all examples.

The toner particles were combined with the surface treatment additives in a KM-LS2K powder mixer available from Dae Wha Tech (South Korea). Admixing occurred at about 2,000 RPMs for 30 seconds followed by a second admixing at about 8,000 RPMs for 3 minutes. After formation, the BET surface area of the electrographic toner was measured by placing the toner particles into a cell and treating them with N₂ gas at 30° C. for 30 minutes. The measuring conditions included helium carrier gas with nitrogen adsorbate flowing at a flow rate of 25 mL/min for a time period of 900 seconds. The measurements were taken in triplicate and the D50 value and standard deviation were calculated. The D50 and standard deviation are shown for each toner in Table 1B above.

### Example 2—Experimental Testing of Electrographic Toners

The electrographic toners from Example 1 were tested for various print properties.

To measure minimum film-forming temperature (MFT), a fixing unit was preheated to 150° C. and an output pattern of thin lines was printed using an HP LaserJet MFP E82560 printer onto 10 cellulosic pages to determine whether an off-set existed.

Image organic photoconductor (OPC) filming was evaluated on printed substrates after 7K/day running under 0° C. at 10% moisture. The filming condition on the OPC surface was observed with LSM and the levels were marked.

The charging property was evaluated by an EPPING Q/M meter at high temperature conditions (30° C. and 80% relative humidity) and at low temperature conditions (10° C. and 10% relative humidity). The EPPING Q/M meter was operated at a voltage of 105 V and an air flow of 2.0 L/minute. The samples were prepared for testing by admixing 0.5 g of the toner formulation with 9.5 g of a carrier in a 200 cc bottle and mixing it with a tubular mixer for three minutes. The sample was left unattended at either the high temperature conditions or the low temperature conditions for a set period of time. Then the samples were evaluated by the EPPING Q/M meter. An HH/LL (high temperature and high humidity (H/H) or low temperature and low humidity (L/L)) Q/M (as determined by EPPING meter) ratio of 80% or more was excellent, an HH/LL Q/M ratio from 70% to less than 80% was good, an HH/LL Q/M ratio from 60% to less than 70% was acceptable, and an HH/LL Q/M ratio of 60% or less indicated bad charging performance.

Image background performance was determined from prints printed for 1 day 7k with 2% coverage at 32° C. and 80% humidity. An optical density (OD) was measured at three locations by taping the non-image area of the OPC drum and measuring optical density with an electro-eye reflection densitometer. Optical density of less than 0.02 indicated very good background performance. Optical density from 0.02 to 0.03 indicated excellent background performance. Optical density of from 0.031 to 0.05 indicated that the background performance was poor. An optical density of 0.051 or more indicated that the background performance was very poor.

Charging speed was measured with an E-spart measuring instrument. 1 g of toner was admixed in a tubular mixer for 10 min. An additional 0.7 g of the toner formulation was added thereto and mixed at 5, 10, 20, 30, and 60 seconds. The closer to CV peak value was to 1, the more stable the charging speed was.

Thermal stability was measured by exposing 2 g of toner at a 1 mm amplitude sleeve for a vibration time of 40 seconds. After standing at 53° C. and 80% humidity for 16 hours, an amount of change under each sieve was calculated.

In addition, the cleaning performance was observed on the photographic printer. When the fumed silica included a siloxane compound of PDMS, the cleaning performance was more effective than the fumed silica including a siloxane compound of HDMS.

The data collected is provided in Table 2, as follows:

TABLE 2
Electrographic Toner Performance Data

| Example | MFT | OPC | Charging | Image | Charging | Thermal |
|---|---|---|---|---|---|---|
| Formulation | (° C.) | Filming | Property | Background | Speed | Stability |
| 1 | 150 | 0 | Excellent | Very Good | 1 | Good |
| 2 | 150 | 0 | Excellent | Very Good | 1 | Very Good |
| 3 | 150 | 0 | Excellent | Excellent | 1 | Very Good |
| C1 | 150 | 0 | Good | Poor | 3 | Slightly |
| | | | | | | Poor |
| C2 | 150 | 0 | Good | Good | 3 | Slightly |
| | | | | | | Poor |
| C3 | 150 | 2 | Poor | Very Good | 1 | Very Good |
| C4 | 150 | 0 | Good | Poor | 2 | Poor |
| C5 | 150 | 1 | Poor | Poor | 3 | Very Good |
| C6 | 150 | 0 | Good | Poor | 3 | Very Good |

As can be seen by the data collected, Example Formulations 1-3 performed the best overall in all of the categories, whereas the Control examples in many cases performed well in some categories, but underperformed in others.

What is claimed is:

1. An electrographic toner, comprising:
toner particles having a specific surface area from 3.0 m²/g to 3.65 m²/g and including a binder resin, a colorant, and a releasing compound;
a multi-particulate additive disposed on an exterior surface of the toner particles, the multi-particulate additive comprising:
aluminum oxide particles,
small sol-gel silica particles having a particle size distribution from 20 nm to 50 nm,
large sol-gel silica particles having a particle size distribution from 90 nm to 130 nm, and
fumed silica particles that are surface-treated polydimethylsiloxane.

2. The electrographic toner of claim 1, wherein the aluminum oxide particles have a D50 particle size from 10 nm to 30 nm and a specific surface area from 80 m²/g to 120 m²/g.

3. The electrographic toner of claim 1, wherein the small sol-gel silica particles are present at from 5 to 40 parts by weight per 100 parts by weight of the toner particles, and the large sol-gel silica particles are present at from 5 to 40 parts by weight per 100 parts by weight of the toner particles.

4. The electrographic toner of claim 1, wherein the small sol-gel silica particles have a specific surface area from 30 m²/g to 60 m²/g and the large sol-gel silica particles have a specific surface area from 30 m²/g to 48 m²/g.

5. The electrographic toner of claim 1, wherein the small sol-gel silica particles have a circularity from 0.9 to 1 and the large sol-gel silica particles have a circularity of from 0.9 to 1.

6. The electrographic toner of claim 1, wherein the fumed silica particles have a D50 particle size from 30 nm to 50 nm, a circularity from 0.3 to 0.5, and a specific surface area from 20 m²/g to 60 m²/g.

7. The electrographic toner of claim 1, aluminum oxide is surface treated with a hydrophobic compound including a C4 to C10 alkyl silane.

8. The electrographic toner of claim 1, wherein the electrographic toner excludes titanium dioxide.

9. The electrographic toner of claim 1, wherein the toner particles include:
from 70 wt % to 95 wt % of the binder resin in the form of polymer particles,
from 4 wt % to 20 wt % of the colorant in the form of pigment particles, and
from 3 wt % to 10 wt % of the releasing compound,
wherein weight percentages are based on a total weight of the toner particles, and
wherein the electrographic toner has a D50 particle size from 3 μm to 9 μm.

10. The electrographic toner of claim 1, wherein the electrographic toner is loaded in a toner cartridge for electrostatic printing.

11. A method of making electrographic toner, comprising:
admixing toner particles with aluminum oxide particles, small sol-gel silica particles having a particle size distribution from 20 nm to 50 nm, large sol-gel silica particles having a particle size distribution from 90 nm to 130 nm, and fumed silica particles having a D50 particle size from 30 nm to 50 nm surface-treated with polydimethylsiloxane, wherein the admixing occurs in a chamber at an intensity sufficient to cause the toner particles to be surface-treated with the aluminum oxide particles, the small sol-gel silica particles, the large sol-gel silica particles, and the fumed silica particles, wherein the toner particles have a specific surface area from 3.0 m²/g to 3.65 m²/g and include a binder resin, a colorant, and a releasing compound; and
recovering the electrographic toner from the chamber.

12. The method of claim 11, wherein the small sol-gel particles have a circularity from 0.9 to 1, the large sol-gel silica particles have a circularity of from 0.9 to 1, and the fumed silica particles have a circularity of from 0.3 to 0.5.

13. The method of claim 11, wherein the aluminum oxide particles have a D50particle size from 10 nm to 30 nm and a specific surface area from 80 m²/g to 120 m²/g.

13. The method of claim 11, wherein the small sol-gel silica particles are present at from 5 to 40 parts by weight per 100 parts by weight of the toner particles and the large sol-gel silica particles are present at from 5 to 40 parts by weight per 100 parts by weight of the toner particles, and wherein the small sol-gel silica particles have a specific surface area from 30 m²/g to 60 m²/g and the large sol-gel silica particles have a specific surface area from 30 m²/g to 48 m²/g.

14. A method of forming an image, comprising:
electrostatically forming a latent image on an electrographic toner on a surface of an electrophotographic photoreceptor, electrographic toner comprising:
toner particles having a specific surface area from 3.0 m²/g to 3.65 m²/g and including a binder resin, a colorant, and a releasing compound; and
a multi-particulate additive disposed on an exterior surface of the toner particles, the multi-particulate additive comprising;
aluminum oxide particles surface;
small sol-gel silica particles having a particle size distribution from 20 nm to 50 nm;
large sol-gel silica particles having a particle size distribution from 90 nm to 130 nm; and
fumed silica particles surface-treated with polydimethylsiloxane; and
transferring the latent image to a substrate.

15. The method of claim 14, wherein:
the aluminum oxide particles have a D50 particle size from 10 nm to 30 nm, a specific surface area from 80 mg²/g to 120 m²/g, and are surface treated with hydrophobic compound including a C4 to C10 alkyl silane;
the small sol-gel silica particles are present from 10 to 40 parts by weight per 100 parts by weight of the toner particles and have a specific surface area from 30 m²/g to 60 m²/g;
the large sol-gel silica particles are present from 5 to 40 parts by weight per 100 parts by weight of the toner particles and have a specific surface area from 30 m²/g to 48 m²/g; and
the fumed silica particles have a D50 particle size from 30 nm to 50 nm and have a specific surface area from 20 m²/g to 60 m²/g.
